(19) United States
(12) Patent Application Publication
(10) Pub. No.: US 2015/0301805 A1
(43) Pub. Date: Oct. 22, 2015

(54) SYSTEMS, METHODS, AND APPARATUS FOR A MACHINE-TO-MACHINE AND CONSUMER-TO-MACHINE INTERACTION PLATFORMS

(71) Applicants: Alok Batra, Sunnyvale, CA (US); Jane Ren, Sunnyvale, CA (US)

(72) Inventors: Alok Batra, Sunnyvale, CA (US); Jane Ren, Sunnyvale, CA (US)

(21) Appl. No.: 14/692,513

(22) Filed: Apr. 21, 2015

Related U.S. Application Data
(60) Provisional application No. 61/982,151, filed on Apr. 21, 2014.
(60) Provisional application No. 61/982,155, filed on Apr. 21, 2014.

(51) Int. Cl. G06F 9/44

(52) U.S. Cl. CPC G06F 8/31

(57) ABSTRACT

Systems, methods, and computer readable media for facilitating machine-to-machine and consumer-to-machine communications and workflows are disclosed. Systems include a distributed interstitial platform configured to provide one or more Domain Extensible Languages for the creation of first and second “inverse facing” widgets and a third workflow/process widget. The platform may allow for receiving of instructions, such as from an end user, at the first widget. The platform may allow for the instructions to be processed by the third widget and the machine interactions to be implemented by the second widget integrated with the machine. These instructions may thus be used to operate the machine or device.

### PRIORITY

The present application claims priority to U.S. Provisional Application 61/982,155, filed Apr. 21, 2014, which is hereby incorporated by reference as if submitted in its entirety.

The present application claims priority to U.S. Provisional Application 61/982,151, filed Apr. 21, 2014, which is hereby incorporated by reference as if submitted in its entirety.

### FIELD OF THE INVENTION

The present invention relates to machine-to-machine communications and workflows. In particular, the present invention relates to an interstitial platform for machine-to-machine and consumer-to-machine communications and workflows.

### BACKGROUND OF THE INVENTION

While some machine-to-machine (M2M) solutions can be relatively simple, with a single application operating upon data from a single type of device over one type of communications system, solutions become far more complex as devices and myriad device types proliferate through the world in the age of the Internet of Things (IoT). In such instances, strict application of normalization engines, as known in the art, in which the “language” spoken by the machine on each side of an M2M equation, becomes impractical. Further, advanced M2M (and consumer to machine, or C2M) solutions may have multiple services on the edge node, several different connectivity requirements, various data consumers, and geographically diverse services and devices. Therefore, it may be advantageous to have an intermediary system, rather than a normalization system, such to connect machines and M2M environments seamlessly to business applications and C2M environments.

### SUMMARY OF THE INVENTION

Systems, methods, and computer readable media for facilitating machine-to-machine and consumer to machine environments, communications, and workflows are disclosed. Systems include a distributed interstitial platform (the “Engine”) configured to provide one or more Domain Extensible Languages (DEL) for the creation of first and second “inverse facing” widgets and a third “workflow” widget, respectively. The platform may receive instructions via a first DEL, such as for generation of widgets, intended to interact with an end user. The platform may provide uniform integration points from those first widgets developed via that first DEL to allow for integration with second, “inverse facing” widgets (i.e., machine facing widgets) and the third “workflow” widgets, developed via the second and third DELs. Accordingly, processing and data performed by a machine associated with a second widgets may be seamlessly provided to either the first widgets, the third widgets, or another second widget related to a different machine, without need of normalization. Thereby, the first widget may be used to interoperate and/or obtain data from a machine associated with the second widget, and execute workflow associated with the third widget. Multiple widgets can be selected and combined to create “apps,” which run on the distributed interstitial platform.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates a system of machines offering limiting machine-to-machine capability;

FIG. 2 illustrates potential benefits of embodiments of the present disclosure;

FIGS. 3A and 3B are illustrations of a system according to embodiments of the present disclosure.

FIG. 4 is an illustration of a system according to embodiments of the present disclosure.

FIG. 5 is an illustration of a system according to embodiments of the present disclosure.

### DETAILED DESCRIPTION OF THE EMBODIMENTS

It is to be understood that the figures and descriptions of the present invention have been simplified to illustrate elements that are relevant for a clear understanding of the present invention, while eliminating, for the purpose of clarity, many other elements found in typical similar systems, processes, and materials. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unlike traditional software programming which use one of the imperative languages (such as Java, C++, C) to describe the procedural steps that the computer will execute in order to solve business problems, this interstitial platform, and the apps and widgets it supports, are written with a declarative programming language, which may consist of multiple Domain Extensible Languages (DELs). The DELs describe any specialized business domain (such as communication, configuring machines, business workflows) in descriptive terms that are easily understandable by users (even those who are not familiar with traditional software programming languages). The DELs are constructed in a way that they are interconnected with each other. That is, more specialized concepts in different domains are reducible to more primitive, common concepts. As a simplified example, both the specialized concept of “airplane” and of “patient” are highly qualified terms built on top of the common concept “entity.” Thus “airplane” and “patient” can be reduced to several common primitive concepts, which include entity. “Entity” thus is one of the terms that connect the domain of “airplane” with the domain of “patient.” DELs allow business-minded developers (e.g., designers) to develop widgets and apps in a declarative approach, that is, the developer “declares” what tasks should be accomplished from the particular perspective of a business concern, such as scheduling a machine to be ready for surgery, without having to understand how the step by step instruction for the computer needs to be written. Because the interstitial platform (e.g., engine) “understands” the DELs and the interconnected logic between them, as well as the interconnected logic between specialized DELs and the most primitive language constructs, it can turn, or translate, apps and widgets written in DELs into “instructions” that can be directly executed by the computer without human intervention. It can also connect widgets and apps that are written in different specialized DELs by using the common underlying concepts shared by them. The system (including the platform and the widgets and apps) built with DELs thus provides the connections between machine to machine, machine to business process, and machine to users directly through languages or through artifacts (such as widgets) written with the languages that are interconnected with each other.

Embodiments of the present disclosure facilitate the creation of widgets and apps. Widgets may take the form of stand-alone apps which may be embedded into other apps. Widgets may be used to construct portions of apps, which may interact with one or more machines in enterprise environments, and/or with one or more users. As used herein, a widget may refer to an encapsulated software module that contains one or more of the following structures: entity, property, operation, state, and event. Widgets are written descriptively with Domain Extensible Languages (DEL).

Apps may be used in conjunction with one or more devices. For example, an app may be able to monitor behavior of a device or machine, thus increasing enterprise device awareness. The app may configure devices with rules to align devices with potential business processes and decisions. Further, apps may serve to connect a device to other devices or machines, such as to monitor or control, which may streamline business processes. Also, apps may be used to control apps and/or widgets associated with or integrated with machines or the behaviors thereof. More specifically, apps may automate business processes or improve business outcomes. Unlike enterprise applications, each app captures a particular aspect of machine or user function, whereas the underlying interstitial platform provides the communication and resource management, states and jobs management, object (file) management, security and common models & interfaces. This allows a collection of apps to have independent execution/interaction while keeping shared resources from the platform.

Apps may be useful in providing insight to many environments, including but not limited to industrial machines, healthcare equipment and devices, scientific instruments, and manufacturing equipment. As an example of applicability to healthcare, a centralized medical equipment state monitoring and configuration app may allow biomedical engineers to increase operating room uptime with lower costs. As another example, an app may send data across medical equipment based on a physician's preference or instruction. This may allow physicians to treat more patients in a given time.

Embodiments of the present disclosure are directed to the platform which may provide for systems and/or enable methods for building, deploying and run-time support of the aforementioned apps and widgets. In short, apps may allow end users the ability to monitor, control, configure, and connect to various machines having associated therewith widgets interconnectivity to the user apps, such as based upon Domain Extensible Languages.

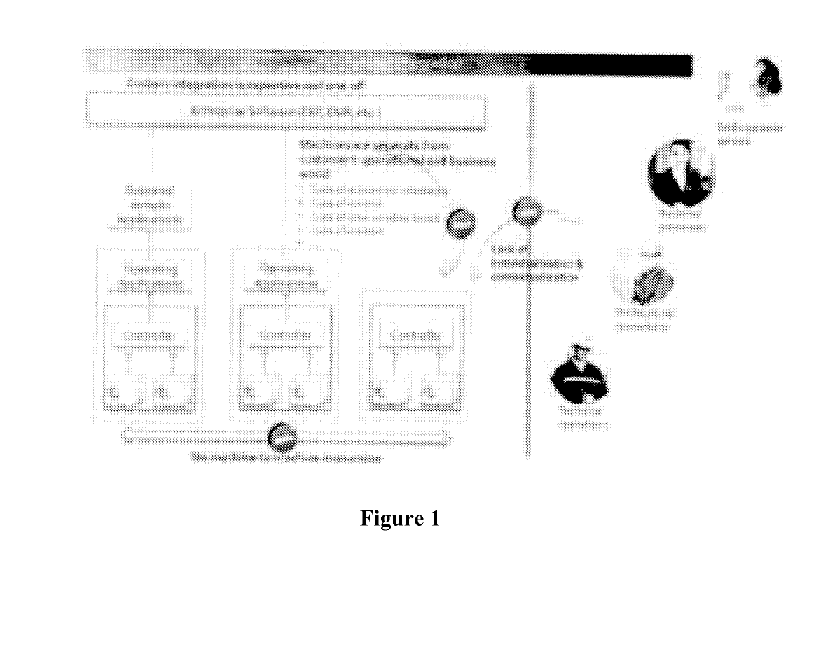

FIG. 1 illustrates a system of machines offering limiting machine-to-machine capability. Traditionally, machine-to-machine environments have consisted of piecemeal technologies wrangled together from disparate vendors that do not, for the most part and absent significant normalization intermediary efforts, communicate or learn from each other. As such, machines, even machines having common purpose but of different types, are essentially siloed. Further, machines are separate from a human user's operational and business world, which is largely mobile and is frequently thus based on portable devices and apps resident thereon. This separation may lead to loss of actionable interfaces, loss of control, loss of time to act, loss of context, and the like. Historically, any integration across machines and between machines and users requires high levels of customization and normalization, which can be prohibitively expensive and which typically provides only a “droplet in the ocean solution”—that is, the customization and normalization provides interoperability only for the particular machines for which the customization and normalization is performed. As such, embodiments of the present disclosure employ a distributed and programmable interstitial platform designed to act as an intermediary system for the development and offering of connections between machine processes, users, and business processes, and for orchestration of machine to machine interactions. Further, embodiments may enable quick development time for apps driven by end users and interactive with machines.

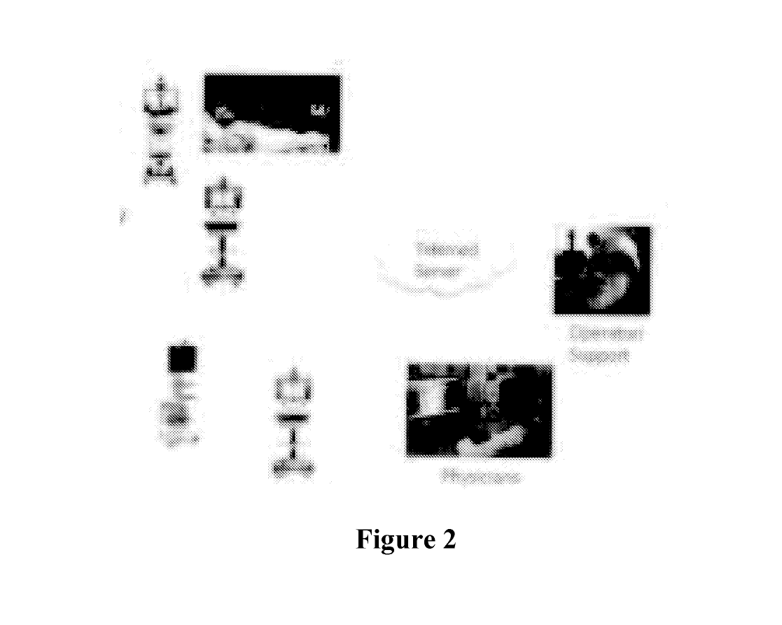

FIG. 2 illustrates embodiments of the present disclosure. A typical scenario may require an operator to perform daily test calls of machines at site, such as to ensure the machines are operating properly. If the operator encounters any issues, he or she may call IT on site with instructions to remedy the issue. In the unfortunate event the issue is not resolved; the operator may need to travel to the site to troubleshoot. This extra time spent fixing an issue may cause, for example, physicians (who regularly depend on the proper operation of these machines) frustration due to this downtime. As such, embodiments of the disclosure may increase uptime, performance, and user satisfaction by, at least in part, allowing users, such as physicians, and other operators the ability to quickly monitor key parameters of all systems, regardless of the vendor. If there is any issue with a machine, instead of the operator constantly having to perform daily diagnostic tests, an alert may be automatically generated to notify the operator, and/or a troubleshooting user app may allow for direct insight into the machine's operation by accessing the “machine-facing” app for that machine.

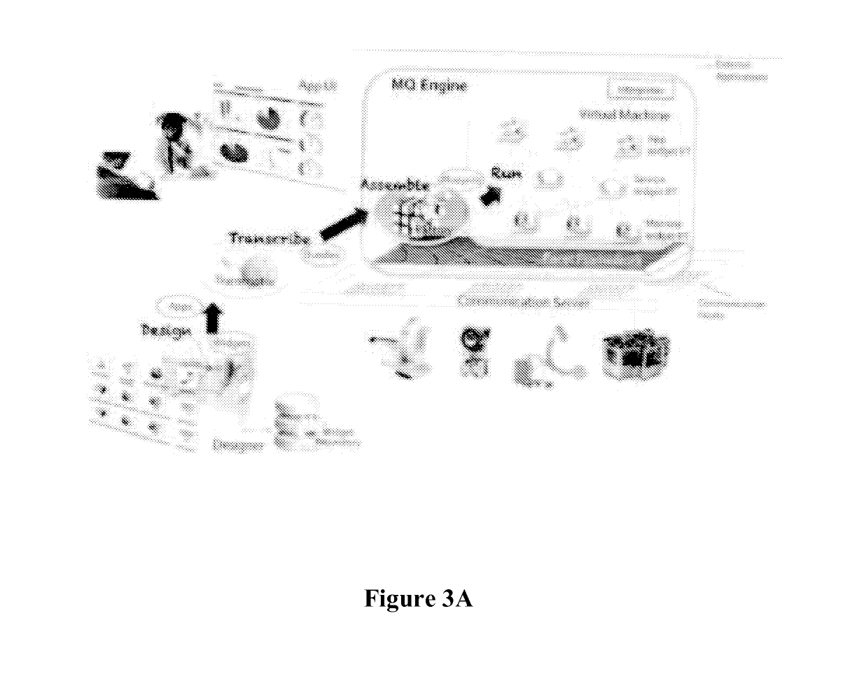

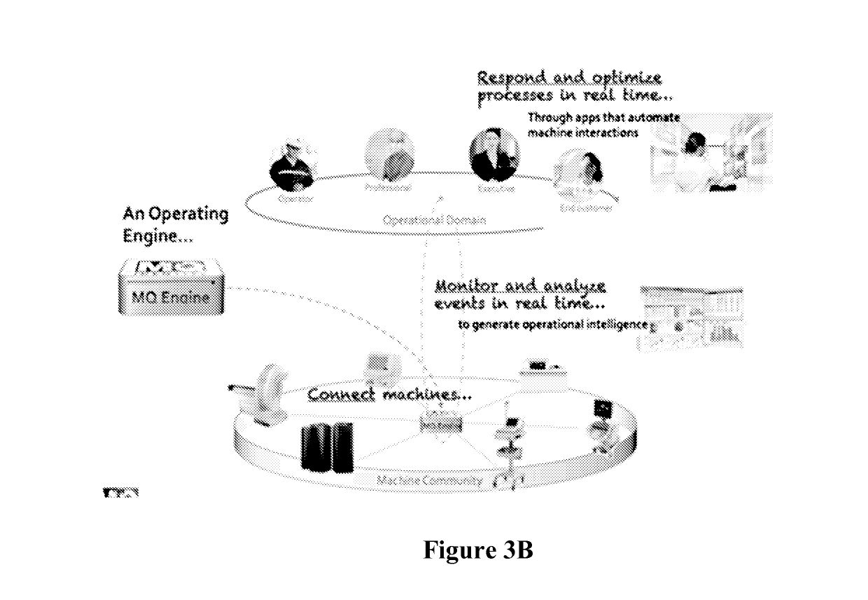

FIGS. 3A and 3B are illustrations of systems according to embodiments of the present disclosure. As shown, embodiments are directed to an interstitial platform that provides one or more Domain Extensible Languages to allow for the creation of apps and widgets to be “inverse facing,” i.e., to be “user facing” and “machine facing.” Embodiments are thus directed to an integrated platform that establishes multiple entry points, and that provides common integration points for apps and widgets designed within the platform.

Developers (e.g., designers) may develop widgets that are able to run on the interstitial platform. The widgets may be created in part through use of Domain Extensible Languages, or a repository of existing widgets, which may be used in the development of apps. According to embodiments of the present disclosure, the interstitial platform may take the form of a software layer for use in interworking for a data exchange, and the like, between apps, apps and widgets, or between an app and a network for providing the services of identification, authentication, security, control, multimedia, and the like, related to devices thereon, based upon common integration points for all apps/widgets developed using Domain Extensible Languages or a set of inverse-facing widgets. As such, when a network connects to an app, or apps directly connect to each other, interconnected models are present that allow for all language (DELs) developed widgets to communicate not only with network devices, but also with other apps, having common integration points. Accordingly, the interstitial platform supports interworking between a network and each app, and between apps/widgets.

The interstitial platform (i.e., engine) may, for example, communicate with a wide range of machines through a communication server, which consists of message handler, message broker and protocol modeler. One or more communication servers establish a Communication Fabric at run-time, which interconnects various machines and external applications on a peer-to-peer. (any-to-any) basis across multiple sub-networks. Such a Communication Fabric supports dynamic, any-to-any interactions between Machine-to-Machine, Consumer-to-Machine, and Application-to-Machine. The interactions can be autonomous because they do not require central orchestration on this Fabric. The engine may host various services which use the devices that communicate with the engine. The services may include custom services implemented and hosted in the engine for end users or other third parties.

Communication between apps/widgets, and thus as well with the end users, may be facilitated through a network. The network may be any type of computer or telecommunications network, such as the Internet, the cellular network, or a dedicated or private network. The devices may include any types of devices/sensors/apparatus/systems/machines which may communicate with the engine such as cellular phones, pagers, automobile engine control units, tire pressure monitoring system, health care monitoring systems, security systems, video cameras, photographic cameras, or other devices.

The platform uses a “facet system” to manage all interactions between the software system (which includes the platform, widgets, apps) and external entities (such as users, other applications, and machines). The interactions can be both outbound (software system interacts with external entities) or inbound (when an external entity interacts with the software system).

The mechanisms of such interactions are defined in the form of capabilities that a particular entity can possess. For example, a widget can possess the capability to use protocol A to interact with machine X. With the “facet system,” the interaction capabilities can be regulated to achieve fine-grained security control and responsiveness to external environments.

A facet is a unique software token consisting of an alphanumeric string (facet ID). The facet defines and manages capabilities and assigns them to specific facets. When a facet is given by the facet system to an entity, the entity acquires permission of the capabilities as associated with the facet. Such entities could be a widget, an app, a user, a machine, etc. The capabilities could be access to a machine, ability to invoke a workflow, or ability to send a message.

Capabilities allowed by a facet can be inherited. Any entity that possesses a facet can create new facets from the original facet. The new facets thus created will “inherit” the same or a subset of the capabilities allowed by the original facet. Also, facets can be “delegated”. That is, facet, along with the capabilities it allows, can be passed on from one entity to another. The entity that receives the facet will acquire access to the capabilities allowed by that particular facet.

Further, any entity that has two or more facets can use them to create a new facet which combines the capabilities allowed by each of the facets. The new facet can thus be used to delegate a collection of capabilities to another entity. As such, the facets and the facet system are a strong security mechanism for distributed, multi-device, multi-user systems for machine-to-machine communications and workflows.

The platform may thus allow developers to create apps that are able to run on a dedicated platform, or on any platform to which the interstitial platform may be integrated and/or interconnected. “User facing” apps may contain user interfaces allowing various end users to control, monitor, and configure desired machines through the use of “machine facing” apps. For example, through the use of the Domain Extensible Language, the platform allows for interoperability of the user app with the machine through the machine facing widget, which may be created by a manufacturer or other developer via the same DEL as is created the user app, or via a different DEL having a commonality of integration points with the DEL used to develop the user app. Through this connectivity, the end user has a seamless experience of working with various machines through the use of the user interface app.

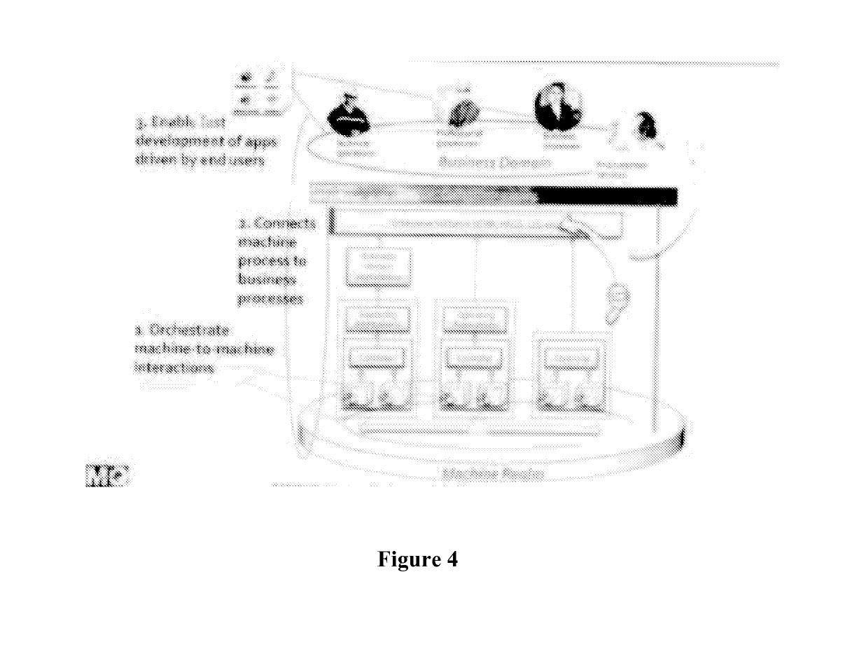

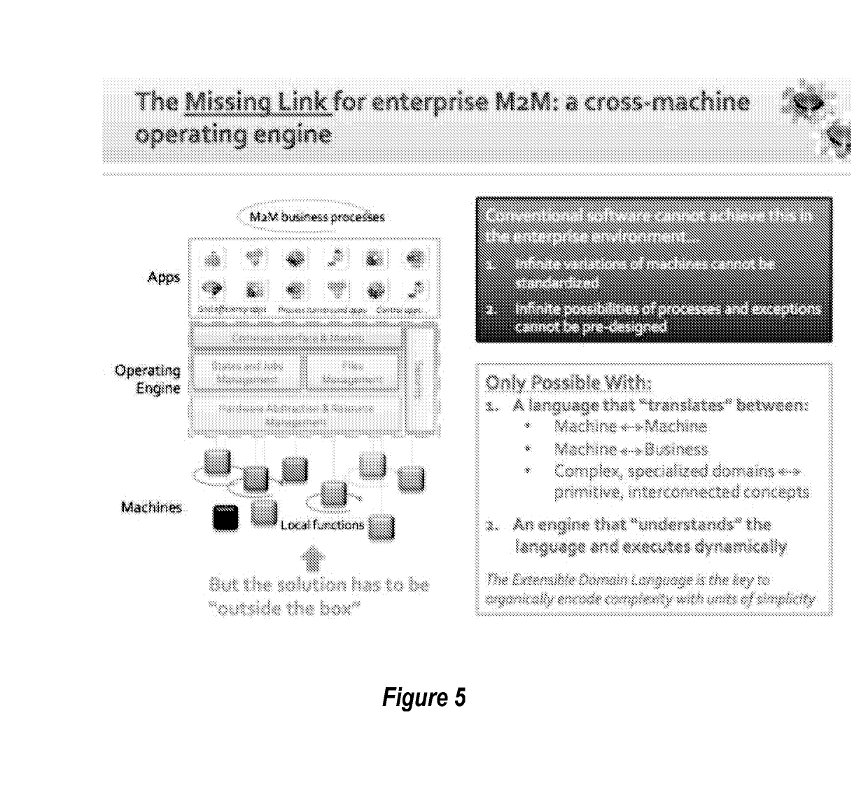

In light of the above disclosure, and as shown in FIGS. 4 and 5, embodiments of the present disclosure also allow for the orchestration of machine-to-machine interactions, the connection of machine processes to business processes, and the quick development and deployment of apps driven by end users. As discussed above, embodiments of the present disclosure also allow for the quick development and deployment of apps to interact with various machines. These apps may be of various types, including but not limited to: service-enabling apps, sales-enabling apps, research and development enabling apps, operator-centric apps, professional centric apps, and executive-centric apps.

Service enabling apps may allow machines to be serviced proactively, thus increasing efficiency. This type of app may enable the remote monitoring, maintenance, or upgrade of the machines.

Sales enabling apps may empower a sales force with machine information, knowledge and timely customer interactions. For example, these apps may automate consumable sales based on machine data from machine apps, or may connect customers in real time to a support personnel from a machine that is currently being operated, or from an app then-associated with that machine being operated.

Research and development enabling apps may facilitate research and development of new/innovative products & services through customer interactions to direct the research, development, prototyping, etc. For example, machine apps running on installed-to machines may allow for experimentation with new features, as well as track reactions, such as customer reactions, to these new features via a user app. Apps may also collect and analyze a customer's machine interaction patterns and use the insight for new product development.

Operator-centric apps may also run on machines themselves to ensure the machines operate properly. These apps can provide real time information, alerts, and simple processes and control mechanisms to simplify an operator's tasks and augment their value. For example, an operator-centric app may send an operator alerts whenever certain parameter (e.g., temperature) of any of the machines at the factory exceed a given limit.

Professional-centric apps may be geared towards professionals, such as doctors, pilots, and scientists. More particularly, these apps may allow professionals to remotely read lab equipment data output, for example, and reconfigure the equipment, at any time, day or night.

Executive-centric apps may facilitate business decisions regarding machines, such as capital investments, or business decisions based on machine-derived intelligence. For example, apps may act across multiple machines, often at a fleet or system level, and can provide relevant information and interactions to create executive level value.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The steps of methods or algorithms described in connection with the disclosure herein may be embodied in hardware, in a software module executed by a processor, and preferably in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in software, wherein the functions may be stored on or transmitted over as one or more instructions or code on a computer-readable medium, and preferably on a non-transitory computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is rather to be accorded the widest scope consistent with the principles and novel features disclosed herein.

1. A method for facilitating machine-to-machine (M2M) and consumer-to-machine (C2M) communications and workflows on an interstitial platform, the method comprising:
providing a first Domain Extensible Language (DEL) to allow for the creation of a first widget for interfacing with a user;
providing a second DEL to allow for the creation of a second widget for interfacing with a machine, wherein the first DEL and the second DEL share a commonality of integration points;
providing a third DEL to allow for the creation of a third widget for carrying out a workflow, wherein the third widgets has shared integration points through DELs with the first and the second widget to relay instructions;
wherein said first widget, said second widget, and said third widget are packaged into an app and deployed on the interstitial platform; and
said first widget receives instructions from the user;
providing the received instructions through integration points between the first, second, and third DELs for processing by the third widget, to carry out the workflow; and
instructing, through the integration points between the third widget and the second widget, the second widget to implement interactions with the machine based on the processed instructions.

2. The method of claim 1, wherein the interstitial platform comprises a communication server and the server further comprises at least one of:
a message handler;
a message broker; and
a protocol modeler.

3. The method of claim 2, wherein the server establishes a communication fabric at run-time.

4. The method of claim 1, wherein the interstitial platform comprises a facet system, wherein the facet system manages all interactions within the platform.

5. The method of claim 4, wherein interactions are either inbound or outbound.

6. The method of claim 4, wherein the facet system assigns a unique software token to said first, second, and third widget.

7. The method of claim 6, wherein each unique software token is associated with one or more capabilities.

8. The method of claim 7, wherein the one or more capabilities include at least one of access to a machine, ability to invoke a workflow, or ability to send a message.

9. The method of claim 8, wherein the unique software token inherits at least one capability associated with an original unique software token.

10. The method of claim 8, wherein the assigned unique software token is a combination of two or more unique software tokens already in use.

11. A system comprising a hardware processor and a memory for facilitating machine-to-machine (M2M), consumer-to-machine (C2M) communications, and workflows on an interstitial platform, the system configured to:
provide a first Domain Extensible Language (DEL) to allow for the creation of a first widget for interfacing with a user;
provide a second DEL to allow for the creation of a second widget for interfacing with a machine, wherein the first DEL and the second DEL share a commonality of integration points;
provide a third DEL to allow for the creation of a third widget for carrying out a workflow, wherein the third widgets has shared integration points through DELs with the first and the second widget to relay instructions;
wherein said first widget, said second widget, and said third widget are packaged into an app and deployed on the interstitial platform; and
said first widget receives instructions from the user;
provide the received instructions through integration points between the first, second, and third DELs for processing by the third widget, to carry out the workflow; and
instruct, through the integration points between the third widget and the second widget, the second widget to implement interactions with the machine based on the processed instructions.

12. The system of claim 11, wherein the interstitial platform comprises a communication server and the server further comprises at least one of:
a message handler;
a message broker; and
a protocol modeler.

13. The system of claim 12, wherein the server establishes a communication fabric at run-time.

14. The system of claim 11, wherein the interstitial platform comprises a facet system, wherein the facet system manages all interactions within the platform.

15. The system of claim 14, wherein interactions are either inbound or outbound.

16. The system of claim 14, wherein the facet system assigns a unique software token to said first, second, and third widget.

17. The system of claim 16, wherein each unique software token is associated with one or more capabilities.

18. The system of claim 17, wherein the one or more capabilities include at least one of access to a machine, ability to invoke a workflow, or ability to send a message.

19. The system of claim 18, wherein the unique software token inherits at least one capability associated with an original unique software token.

20. The system of claim 18, wherein the assigned unique software token is a combination of two or more unique software tokens already in use.
